(19) United States
(12) Patent Application Publication
(10) Pub. No.: US 2025/0163990 A1
(43) Pub. Date: May 22, 2025

(54) DAMPER DEVICE

(71) Applicant: PIOLAX, INC., Kanagawa (JP)

(72) Inventor: Jun SAITO, Kanagawa (JP)

(73) Assignee: PIOLAX, INC., Kanagawa (JP)

(21) Appl. No.: 18/842,411

(22) PCT Filed: Mar. 7, 2023
(86) PCT No.: PCT/JP2023/008516

§ 371 Date: Aug. 29, 2024

(30) Foreign Application Priority Data
Mar. 10, 2022 (JP) 2022-037556

(51) Int. Cl. F16F 9/516; F16F 9/02; F16F 9/36

(52) U.S. Cl. CPC F16F 9/516; F16F 9/0218; F16F 9/0281; F16F 9/368; F16F 2222/126; F16F 2228/066; F16F 2230/30; F16F 2232/08; F16F 2234/02

(57) ABSTRACT

A damper device includes: a cylinder; a rod; a piston having an annular groove; and a seal ring. A bottom portion of the annular groove is provided with a deep bottom portion, and a shallow bottom portion. The seal ring is provided with, on an outer peripheral surface thereof, a cylinder contact portion configured to come into contact with an inner peripheral surface of the cylinder, and is provided with, on an inner peripheral surface thereof, a shallow bottom portion contact portion configured to come into contact with the shallow bottom portion, a center of the cylinder contact portion and a center of the shallow bottom portion contact portion are offset in an axial direction, and the inner peripheral surface of the seal ring does not come into contact with the deep bottom portion when the piston moves in a damper braking direction.

### TECHNICAL FIELD

The present invention relates to a damper device used to brake opening, closing, and the like of a glove box of an automobile.

### BACKGROUND ART

A damper device may be used in, for example, a glove box of an automobile to prevent a lid from being rapidly opened and allow the lid to be gently opened.

As such a damper device, Patent Literature 1 below describes an air damper that includes: a cylinder member; a piston member movably provided inside the cylinder member and having an air passage; a seal member disposed in a recessed portion formed in an outer periphery of the piston member and sealing an inner peripheral surface of the piston member and the cylinder member; a rod member; a pushing portion provided in the rod member and configured to move the piston member when the rod member is pushed into a bottom plate of the cylinder member; and a sucker member configured to open and close the air passage. The seal member is an O-ring having a circular cross section, and the seal member is configured to come into contact with an inner peripheral surface of the cylinder member.

### CITATION LIST

### Patent Literature

Patent Literature 1: JP2010-265990A

### SUMMARY OF INVENTION

### Technical Problem

In the case of the air damper in Patent Literature 1, since the seal member is an O-ring, when the piston moves in a return direction in which a braking force of the damper does not act, a frictional resistance of the seal member against the inner peripheral surface of the cylinder member is high, making it difficult to reduce a force for operating the piston.

Therefore, an object of the present invention is to provide a damper device capable of reducing a force for operating a piston when the piston moves in a return direction opposite to a damper braking direction.

### Solution to Problem

In order to achieve the above object, the present invention provides a damper device configured to be attached between a pair of members that are configured to move toward or away from each other, and configured to apply a braking force when the pair of members move toward or away from each other, the damper device including: a cylinder having an opening portion at one end portion; a rod movably inserted into the cylinder through the opening portion; a piston connected to the rod and having an annular groove formed on an outer periphery thereof; and a seal ring mounted in the annular groove and configured to come into pressure contact with an inner peripheral surface of the cylinder. A bottom portion of the annular groove is provided with a deep bottom portion disposed on a side of a damper braking direction, and a shallow bottom portion disposed on a side opposite to the damper braking direction and shallower than the deep bottom portion. The seal ring is provided with, on an outer peripheral surface thereof, a cylinder contact portion configured to come into contact with the inner peripheral surface of the cylinder, and is provides with, on an inner peripheral surface thereof, a shallow bottom portion contact portion configured to come into contact with the shallow bottom portion, a center of the cylinder contact portion and a center of the shallow bottom portion contact portion are offset in an axial direction, and the inner peripheral surface of the seal ring does not come into contact with the deep bottom portion when the piston moves in the damper braking direction.

### Advantageous Effects of Invention

In the present invention, when the piston moves in a return direction opposite to the damper braking direction, the seal ring is deformed toward the deep bottom portion of the annular groove by a frictional force from the inner peripheral surface of the cylinder acting on the cylinder contact portion, with the shallow bottom portion contact portion in contact with the shallow bottom portion serving as a fulcrum. As a result, a pressure contact force of the cylinder contact portion with the inner peripheral surface of the cylinder is decreased, so that the frictional resistance between the inner peripheral surface of the cylinder and the cylinder contact portion can be reduced, and a force for operating the piston when the piston moves in the return direction can be reduced.

### BRIEF DESCRIPTION OF DRAWINGS

FIG. 1 is an exploded perspective view showing a damper device according to an embodiment of the present invention.

FIG. 2 is a perspective view of the damper device.

FIG. 3 is an enlarged perspective view of a piston forming the damper device when viewed from a direction different from that of FIG. 1.

FIG. 4 is a side view of a rod and the piston forming the damper device.

FIG. 5 is a cross-sectional view taken along a line A-A in FIG. 4.

FIG. 6 is an enlarged perspective view of a seal ring forming the damper device when viewed from a direction different from that of FIG. 1.

FIG. 7 is a cross-sectional view of the seal ring forming the damper device.

FIG. 8 is a cross-sectional view of the damper device, and an enlarged cross-sectional view of a main portion of the damper device.

FIG. 9 is a view illustrating a flow of air in the cylinder when the piston moves in a return direction opposite to a damper braking direction in the damper device.

FIG. 10 is a cross-sectional view of a modification of the seal ring forming the damper device.

FIG. 11 is an enlarged cross-sectional view of a main portion of a damper according to another embodiment of the present invention.

FIG. 12 is an exploded perspective view showing a damper device according to still another embodiment of the present invention.

FIG. 13 is a perspective view of the damper device.

FIG. 14 is an enlarged perspective view of a piston forming the damper device when viewed from a direction different from that of FIG. 12.

FIG. 15 is an enlarged side view of the piston forming the damper device.

FIG. 16 is an enlarged side view of the piston when viewed from a direction different from that of FIG. 15.

FIG. 17 is a cross-sectional view taken along a line B-B in FIG. 13.

FIG. 18 is an enlarged cross-sectional view of main portions, which shows a relationship between the piston, a seal ring, and the like with respect to a cylinder in the damper device.

### DESCRIPTION OF EMBODIMENTS

### Damper Device according to One Embodiment

Hereinafter, a damper device according to one embodiment of the present invention will be described with reference to the drawings.

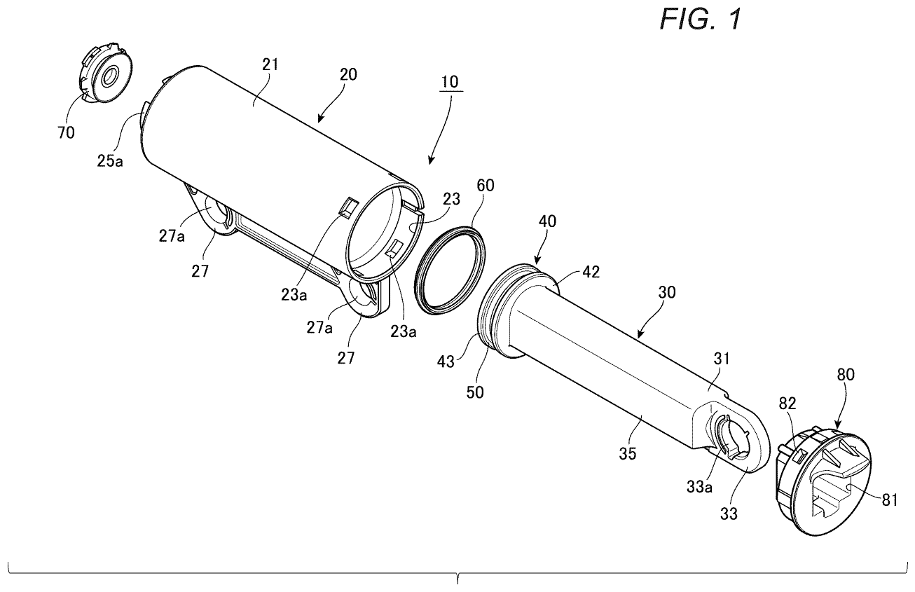

A damper device 10 shown in FIG. 1 is attached to a pair of members that approach and separate from each other, and applies a braking force when the pair of members approach or separate from each other. For example, the damper device 10 can be used to brake a glove box, a lid, or the like that is attached to an opening portion of an accommodation portion in an instrument panel of an automobile in a manner of being openable and closable. In the following embodiment, one of the pair of members is described as a fixed body such as the accommodation portion of the instrument panel, and another of the pair of members is described as an openable and closable body such as the glove box or the lid attached to the opening portion of the fixed body in a manner of being openable and closable.

As shown in FIG. 1, the damper device 10 according to the embodiment mainly

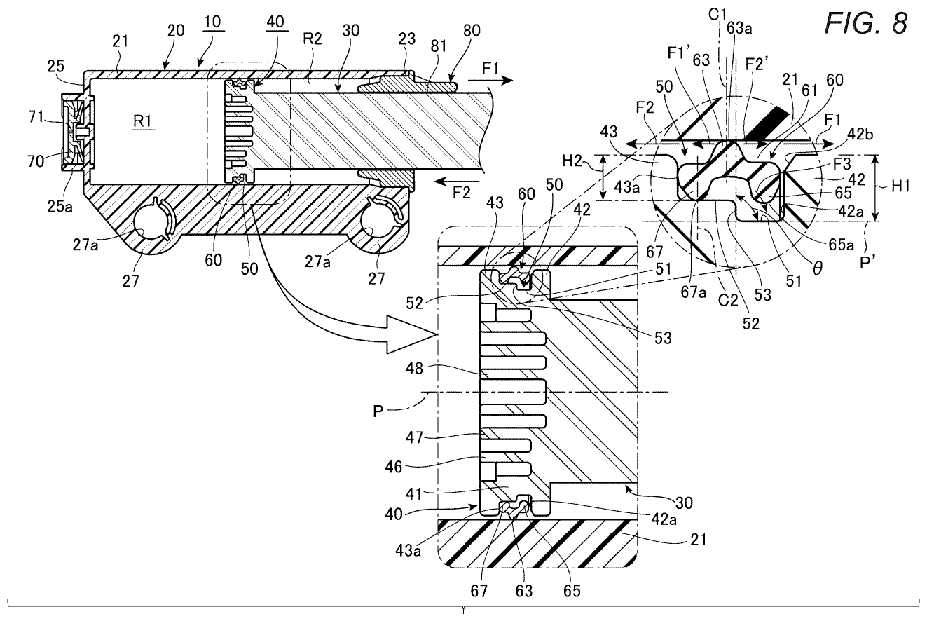

includes: a cylinder 20 having an opening portion 23 at one end portion; a rod 30 movably inserted into the cylinder 20; a piston 40 connected to the rod 30 and having an annular groove 50 formed on an outer periphery; a seal ring 60 mounted on the annular groove 50 of the piston 40; a seal cap 70 mounted on the other end portion of the cylinder 20; and a detachment prevention cap 80 mounted on the opening portion 23 at the one end portion of the cylinder 20. As shown in FIG. 8, when the piston 40 is inserted into the cylinder 20, the seal ring 60 is brought into pressure contact with an inner peripheral surface of the cylinder 20. With the seal ring 60 as a boundary, a first chamber R1 (air chamber) is formed on a side in an insertion direction of the rod 30 in the cylinder 20, and a second chamber R2 is formed on a side of the opening portion 23 of the cylinder 20.

In the following description, “one end portion” or “one end” refers to one end portion or one end of the damper device 10 on a damper braking direction, and “the other end portion” or “the other end” refers the other end portion or the other end on a return direction opposite to the damper braking direction. Further, the “damper braking direction” in the present embodiment refers to a direction in which the piston 40 separates from an end portion wall 25 (see FIG. 8) of the cylinder 20 and an amount of the rod 30 pulled out from the opening portion 23 of the cylinder 20 increases (see an arrow F1 in FIG. 8). In addition, the “return direction opposite to the damper braking direction” (hereinafter, also simply referred to as “damper return direction”) in the present embodiment refers to a direction in which the piston 40 approaches the end portion wall 25 of the cylinder 20 and an amount of the rod 30 pressed into the cylinder 20 increases (see an arrow F2 in FIG. 8).

As shown in FIG. 1, the cylinder 20 has a substantially cylindrical wall portion 21 extending in a predetermined length, and the one end portion in an axial direction of the cylinder 20 is open to provide the opening portion 23. A pair of engaging holes 23a, 23a are formed in a peripheral edge of the opening portion 23 at positions facing each other in a radial direction. Further, as shown in FIG. 8, the end portion wall 25 is disposed at the other end portion of the wall portion 21 (the end portion wall 25 is disposed on a side of the wall portion 21 opposite to the opening portion 23), and the end portion wall 25 is formed with a through hole (not shown). Further, a cap mounting wall 25a protrudes from an outer surface of the end portion wall 25, and the seal cap 70 is mounted on the cap mounting wall 25a.

The seal cap 70 is made of an elastic resin material such as rubber or elastomer, and is mounted on the cap mounting wall 25a. An orifice 71 is formed penetrating the seal cap 70 at a predetermined location (see FIG. 8). At the time of damper braking, the seal cap 70 comes into contact with a peripheral edge of the through hole (not shown) of the end portion wall 25 of the cylinder 20, and the first chamber RI of the cylinder 20 is sealed. When the damper braking force is released, the seal cap 70 is separated from the peripheral edge of the through hole (not shown), and air in the first chamber RI of the cylinder 20 is allowed to be exhausted. The damper braking force is adjusted by flow resistance of the air passing through the orifice 71.

In addition, a rotation support piece 27 having a rotation hole 27a formed therein protrudes from each of both end portions of an outer periphery of the wall portion 21 in the axial direction. A rotating shaft (not shown) of the one member described above is rotatably inserted into the predetermined rotation hole 27a, and an outer periphery of the cylinder 20 is rotatably coupled to the one member.

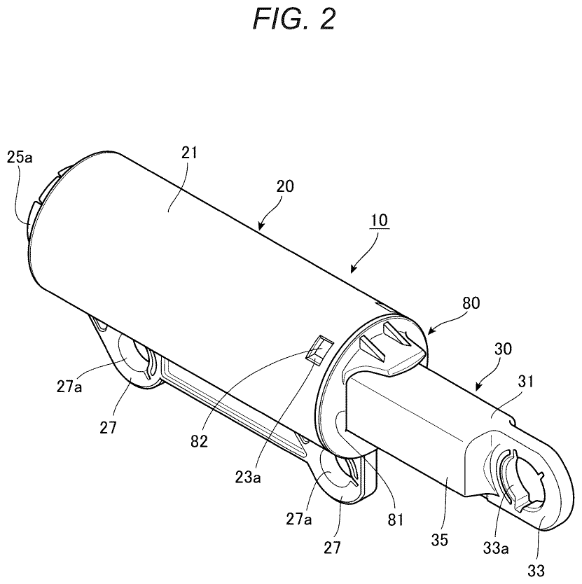

As shown in FIG. 1, the detachment prevention cap 80 bas a rod insertion port 81 formed in the center thereof, the rod insertion port 81 has a shape that fits the shape of the rod 30, and the rod 30 can be inserted into the cylinder 20 while being restricted from rotation. Further, a plurality of engaging protrusions 82 are provided on an outer periphery of the detachment prevention cap 80 at predetermined positions. The detachment prevention cap 80 is attached to the opening portion 23 of the cylinder 20 (see FIG. 8) by engaging each of the engaging protrusions 82 with the corresponding engaging hole 23a of the cylinder 20 (see FIG. 2). When the rod 30 is pulled out to the maximum from the opening portion 23 of the cylinder 20, the detachment prevention cap 80 comes into contact with the piston 40 to prevent the rod 30 and the piston 40 from coming off the cylinder 20.

Next, the rod 30 will be described.

The rod 30 is movably inserted into the cylinder 20 through the opening portion 23 of the cylinder 20, and slides in the cylinder 20 in the axial direction of the cylinder 20.

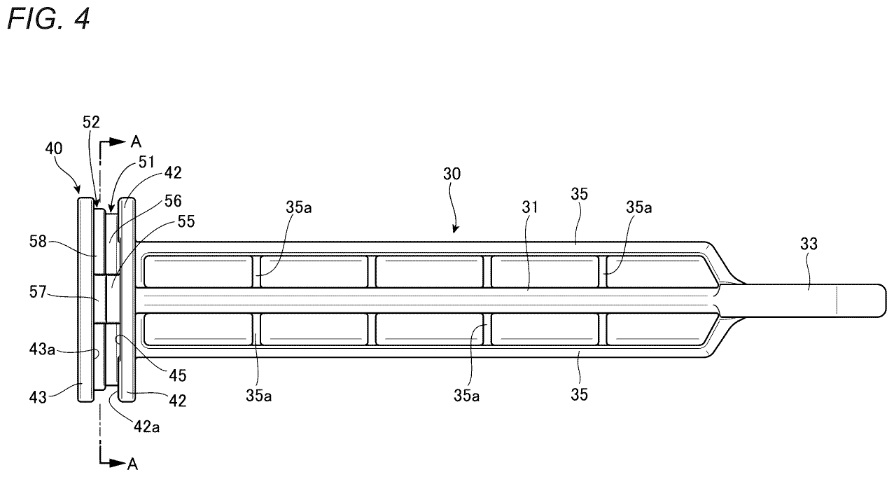

As shown in FIGS. 1 and 4, the rod 30 in the embodiment has the shaft portion 31 in a shape of a substantially elongated plate that extends long in one direction. A coupling piece 33 having a coupling hole 33a is provided at one end portion in a longitudinal direction of the shaft portion 31. A coupling shaft (not shown) of the other member described above is inserted into the coupling hole 33a, so that the rod 30 is rotatably coupled to the other member. As shown in FIG. 4, on both sides of the shaft portion 31, a pair of side walls 35, 35 each having a long plate shape extending parallel to each other are disposed with a plurality of ribs 35a interposed therebetween. Each side wall 35 is disposed to face an inner side surface of the rod insertion port 81 of the detachment prevention cap 80, and restricts rotation of the rod 30.

Next, the piston 40 will be described.

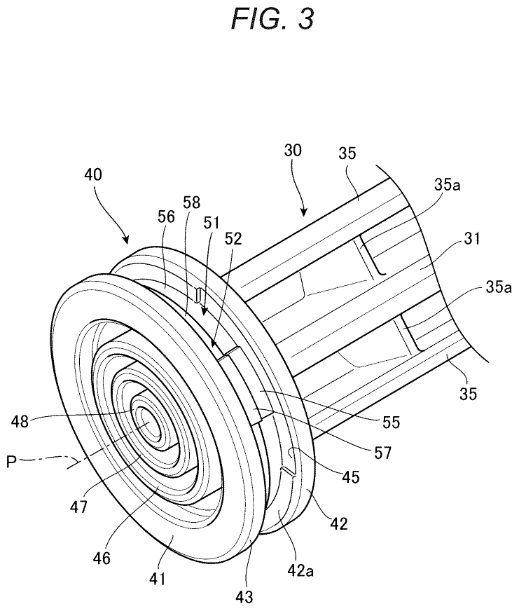

As shown in FIG. 3 and FIG. 4, the piston 40 of the present embodiment is coupled to the other end portion in the longitudinal direction of the rod 30, the annular groove 50 is formed on the outer periphery of the piston 40, and the piston 40 is integrally formed with the rod 30.

Referring also to FIG. 8, the piston 40 includes a peripheral wall portion 41 having a substantially cylindrical shape extending a predetermined length along an axial direction of the rod 30, and a first annular wall portion 42 and a second annular wall portion 43 that are connected to one end portion and the other end portion in the axial direction of the peripheral wall portion 41 and that protrude annularly from an outer peripheral surface of the peripheral wall portion 41 toward an outer side in a radial direction. The first annular wall portion 42 and the second annular wall portion 43 protrude perpendicular to an axis P of the piston 40 and parallel to each other. A base end portion in the axial direction of the rod 30 is coupled to an outer surface of the first annular wall portion 42 (a surface opposite to a surface facing the second annular wall portion 43), so that the piston 40 and the rod 30 are integrated.

A surface of the first annular wall portion 42 facing the second annular wall portion 43 is defined as an inner surface 42a of the first annular wall portion 42, and a surface of the second annular wall portion 43 facing the first annular wall portion 42 is defined as an inner surface 43a of the second annular wall portion 43. An amount (length in the radial direction) by which the first annular wall portion 42 protrudes from the axis P of the piston 40 and an amount by which the second annular wall portion 43 protrudes from the axis P of the piston 40 are the same. Further, as shown in FIG. 3, a recessed portion 45 recessed to a predetermined depth in a thickness direction of the first annular wall portion 42 is formed on the inner surface 42a of the first annular wall portion 42 within a predetermined range in a peripheral direction. Further, as shown in FIG. 8, a chamfered portion 42b that is chamfered at a predetermined angle is formed on the inner surface 42a of the first annular wall portion 42 at a tip end portion in a protruding direction.

As shown in FIG. 3, a plurality of cylindrical walls 46, 47, 48 are provided concentrically with the axis P of the piston 40 on an inner side of the peripheral wall portion 41 of the piston 40.

A space surrounded by the peripheral wall portion 41, the first annular wall portion 42, and the second annular wall portion 43 forms the annular groove 50.

Referring also to FIG. 8, a bottom portion of the annular groove 50 (also referred to as an outer peripheral portion of the peripheral wall portion 41) is provided with a deep bottom portion 51 arranged on a damper braking direction F1 side, and a shallow bottom portion 52 that is arranged on a side opposite to the damper braking direction F1 and shallower than the deep bottom portion 51.

In the embodiment, the deep bottom portion 51 is the bottom portion of the annular groove 50, is disposed on a side of the first annular wall portion 42, and is formed to be parallel to the axial direction of the piston 40 (the direction along the axis P of the piston 40). A depth of the deep bottom portion 51, that is, a length in the radial direction of the deep bottom portion 51 from an outer peripheral surface of the piston (a length in the radial direction from top portions of the annular wall portions 42 and 43) is defined as “H1”.

Further, in the embodiment, the shallow bottom portion 52 is the bottom portion of the annular groove 50, is disposed on a side of the second annular wall portion 43, and is formed to be parallel to the axial direction of the piston 40. A depth of the shallow bottom portion 52, that is, a length in the radial direction of the shallow bottom portion 52 from the outer peripheral surface of the piston is defined as “H2”. The depth H2 of the shallow bottom portion 52 is smaller than the depth HI of the deep bottom portion 51, and the shallow bottom portion 52 is shallower than the deep bottom portion 51. That is, the “shallow bottom” in the present invention means that the depth (length in the radial direction) from the outer peripheral surface of the piston is smaller than the depth of the deep bottom portion from the outer peripheral surface of the piston.

Between the deep bottom portion 51 and the shallow bottom portion 52, there is a portion inclined at an angle larger than an angle of the deep bottom portion 51 with respect to the axial direction of the piston 40 and an angle of the shallow bottom portion 52 with respect to the axial direction of the piston 40.

In the case of the embodiment, as shown in FIG. 8, an inclined portion 53 is provided between the deep bottom portion 51 and the shallow bottom portion 52, that is, on a surface of the deep bottom portion 51 on a side opposite to the inner surface 42a of the first annular wall portion 42 and a surface of the shallow bottom portion 52 on a side opposite to the inner surface 43a of the second annular wall portion 43. An inclined angle θ of the inclined portion 53 with respect to the axial direction of the piston 40 (an angle with respect to a line segment P′ parallel to the axis P of the piston 40) is 90° (the inclination angle can be said to be vertical). In other words, a step portion is provided by the inclined portion 53 between the deep bottom portion 51 and the shallow bottom portion 52.

As shown in FIG. 3, the deep bottom portion 51 has a shallow portion 55 and a deep portion 56 in the peripheral direction of the annular groove 50, and similarly, the shallow bottom portion 52 has a shallow portion 57 and a deep portion 58 in the peripheral direction of the annular groove 50.

The shallow portion 55 of the deep bottom portion 51 is formed to have a smaller

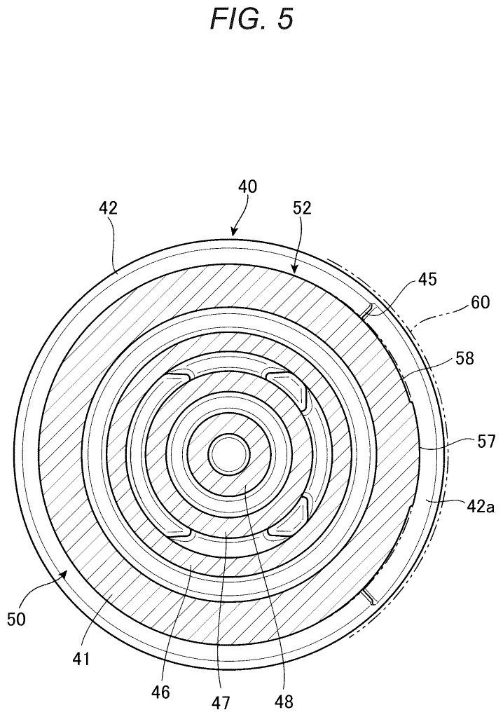

depth from the outer peripheral surface of the piston than the deep portion 56, and the shallow portion 57 of the shallow bottom portion 52 is formed to have a smaller depth from the outer peripheral surface of the piston than the deep portion 58. The deep portion 58 of the shallow bottom portion 52 is formed to have a smaller depth from the outer peripheral surface of the piston than the shallow portion 55 of the deep bottom portion 51. Further, as shown in FIGS. 4 and 5, the shallow portion 55 of the deep bottom portion 51 and the shallow portion 57 of the shallow bottom portion 52 are provided to have a shorter width along the peripheral direction than that of the recessed portion 45 formed in the inner surface 42a of the first annular wall portion 42, and are positioned at an intermediate portion in the peripheral direction of the recessed portion 45.

Next, the seal ring 60 will be described.

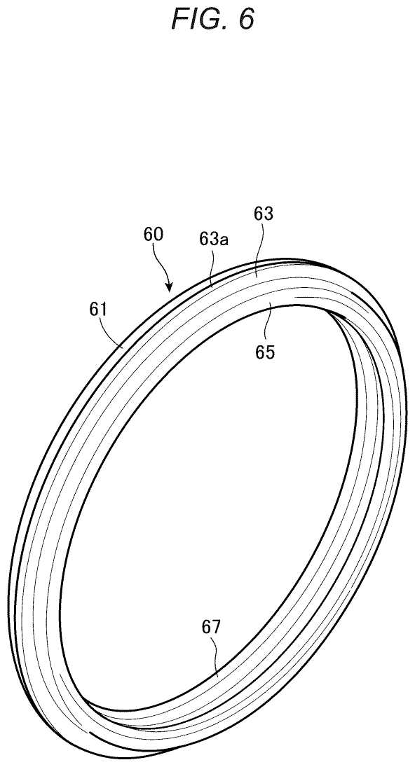

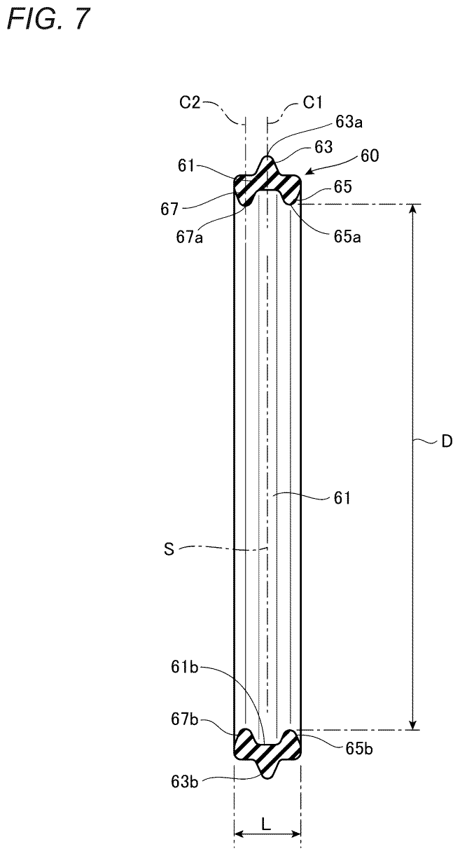

As shown in FIGS. 6 and 7, the seal ring 60 is made of an elastic material such as rubber or elastomer, and has a base portion 61 having a substantially annular shape. The base portion 61 has an inner diameter D larger than an outer diameter of the deep bottom portion 51 and the shallow bottom portion 52, which are the bottom portion of the annular groove 50, and an axial length L smaller than a width in the axial direction of the annular groove 50 (a length between the first annular wall portion 42 and the second annular wall portion 43), so that the base portion 61 is disposed on an outer periphery of the annular groove 50 as shown in FIG. 8. The axial length L of the base portion 61 is formed smaller than the width in the axial direction of the annular groove 50, so that the seal ring 60 is able to move in the axial direction within the annular groove 50.

Further, the seal ring 60 is provided with, on an outer peripheral surface, a cylinder contact portion to come into contact with the inner peripheral surface of the cylinder 20, and on an inner peripheral surface, a shallow bottom portion contact portion to come into contact with the shallow bottom portion 52. In the case of this embodiment, the inner peripheral surface of the cylinder 20 refers to the inner peripheral surface of a wall portion 21 forming the cylinder 20, and this also applies to the following description.

Specifically, a first annular protruding portion 63 protrudes from an outer peripheral surface (outer diameter side surface) of the base portion 61 at the intermediate portion in the axial direction. Further, a second annular protruding portion 65 and a third annular protruding portion 67 protrude from an inner peripheral surface (inner diameter side surface) of the base portion 61 at both end portions in the axial direction. The annular protruding portions 63, 65, and 67 protrude continuously in the peripheral direction from the outer peripheral surface or the inner peripheral surface of the base portion 61 outward in the radial direction of the base portion 61 to form an annular shape. The second annular protruding portion 65 is disposed on one end portion side in the axial direction of the base portion 61, that is, on the damper braking direction F1 side, and the third annular protruding portion 67 is disposed on the other end portion side in the axial direction of the base portion 61, that is, on a damper return direction F2 side opposite to the damper braking direction F1.

Each of the annular protruding portions 63, 65, and 67 has a generally mountain-shaped (which may also be referred to as a divergent shape) cross section having side surfaces 63b, 63b, 65b, 65b, 67b, and 67b that gradually become wider from top portions 63a, 65a, 67a at the tip end in the protruding direction towards the base end in the protruding direction. The top portions 63a, 65a, 67a of the annular protruding portions 63, 65, 67 are rounded. Further, the top portion 63a of the first annular protruding portion 63 is located at the center in the axial direction of the seal ring 60. As shown in FIG. 7, the entire seal ring 60 has a cross-sectional shape that is line-symmetrical with respect to an axis center line S passing through the center in the axial direction (a line perpendicular to the axial direction of the seal ring 60 and passing through the top portion 63a of the first annular protruding portion 63).

A thickness dimension in the radial direction of the seal ring 60, that is, a length from the top portion 63a of the first annular protruding portion 63 to the top portion 65a of the second annular protruding portion 65 and the top portion 67a of the third annular protruding portion 67 is larger than a length from the inner peripheral surface of the cylinder 20 to the shallow bottom portion 52 of the annular groove 50. As a result, in a state where the seal ring 60 is mounted on the annular groove 50, when the piston 40 is inserted into the cylinder 20, the top portion 63a of the first annular protruding portion 63 is in pressure contact with the inner peripheral surface of the cylinder 20.

That is, the top portion 63a of the first annular protruding portion 63 is constantly in contact with the inner peripheral surface of the cylinder 20 (see FIG. 8), and the first annular protruding portion 63 forms the “cylinder contact portion” in the present invention. Note that “constantly” refers to all states in which the piston 40 is within the cylinder 20, that is, a state in which the piston 40 is stationary, a state in which the piston 40 is moved in the damper braking direction F1, and a state in which the piston 40 is moved in the damper return direction F2 (the same applies to the following description).

The top portion 67a of the third annular protruding portion 67 is constantly in contact with the shallow bottom portion 52 (see FIG. 8), and the third annular protruding portion 67 forms the “shallow bottom portion contact portion” in the present invention.

In the seal ring 60, a center C1 of the cylinder contact portion (the first annular protruding portion 63) and a center C2 of the shallow bottom portion contact portion (the third annular protruding portion 67) are offset in the axial direction of the seal ring 60. Therefore, the inner peripheral surface of the seal ring 60 does not come into contact with the deep bottom portion 51 when the piston 40 moves in the damper braking direction F1. When the piston 40 moves in the damper return direction F2 opposite to the damper braking direction F1, a part of the inner peripheral surface of the seal ring 60 is deformed toward the deep bottom portion 51.

In this embodiment, the center C1 of the cylinder contact portion refers to a position that passes through the center of the first annular protruding portion 63 in the axial direction (a location where the top portion 63a of the first annular protruding portion 63 is positioned) and is perpendicular to the axial direction of the seal ring 60 (the same position as the axis center line S). The center C2 of the shallow bottom portion contact portion refers to a position that passes through the center of the third annular protruding portion 67 in the axial direction (a location where the top portion 67a of the third annular protruding portion 67 is positioned) and is perpendicular to the axial direction of the seal ring 60.

Further, the annular protruding portion (the second annular protruding portion 65) positioned on the damper braking direction F1 side is located at the deep bottom portion 51, and does not come into contact with the deep bottom portion 51 when the piston 40 moves in the damper braking direction F1. That is, even when the piston 40 moves in the damper braking direction F1, the top portion 65a of the second annular protruding portion 65 does not come into contact with the deep bottom portion 51.

Here, the operation of the seal ring 60 in the annular groove 50 when the piston 40 moves in the damper braking direction F1 and when the piston 40 moves in the damper return direction F2 will be described.

In a state in which the piston 40 is stationary, the seal ring 60 is disposed in the annular groove 50 in a state in which the top portion 63a of the first annular protruding portion 63 is in contact with (is in pressure contact with) the inner peripheral surface of the cylinder 20, and the top portion 67a of the third annular protruding portion 67 is in contact with the shallow bottom portion 52.

When the piston 40 moves in the damper braking direction F1 from this state, a frictional force F1′ acts on the first annular protruding portion 63 from the inner peripheral surface of the cylinder 20 in a direction opposite to the damper braking direction F1.

Then, the seal ring 60 is pressed in the direction of the frictional force F1′ in the annular groove 50, so that the other end portion in the axial direction of the base portion 61 of the seal ring 60 comes into contact with the inner surface 43a of the second annular wall portion 43 of the annular groove 50, and the posture of the seal ring 60 is maintained by the tension of the third annular protruding portion 67 in contact with the shallow bottom portion 52.

In the above state, a gap between the inner surface 43a of the second annular wall portion 43 and the other end portion in the axial direction of the base portion 61 is sealed, and a gap between the inner peripheral surface of the cylinder 20 and the outer peripheral surface of the seal ring 60 is also sealed, so that the pressure in the first chamber R1 inside the cylinder 20 is reduced, and a damper braking force is exerted.

On the other hand, when the piston 40 moves in the damper return direction F2, a frictional force F2′ acts on the first annular protruding portion 63 from the inner peripheral surface of the cylinder 20 in a direction opposite to the damper return direction F2.

Then, with the third annular protruding portion 67 in contact with the shallow bottom portion 52 as a fulcrum, the one end portion in the axial direction of the seal ring 60 is deformed toward the deep bottom portion 51 as indicated by an arrow F3 in FIG. 8. In the embodiment, the seal ring 60 is deformed (tilted) so as to roll with the third annular protruding portion 67 as a fulcrum, the second annular protruding portion 65 is inserted deeply into the deep bottom portion 51, and the top portion 65a comes close to or comes into contact with the deep bottom portion 51. As a result, a pressure contact force of the first annular protruding portion 63 with respect to the inner peripheral surface of the cylinder 20 decreases, and the frictional resistance between the inner peripheral surface of the cylinder 20 and the first annular protruding portion 63 decreases.

Further, the seal ring 60 is configured to be constantly in contact with the shallow portion 57 and the deep portion 58 of the shallow bottom portion 52.

That is, as shown by the two-dot chain line in FIG. 5, in a state in which the seal ring 60 is mounted on the annular groove 50, an inner peripheral portion of the seal ring 60 (although not shown here, the top portion 67a of the third annular protruding portion 67 at a predetermined position in the peripheral direction) comes into contact with the shallow portion 57 of the shallow bottom portion 52, and portions of the seal ring 60 other than the inner peripheral portion in contact with the shallow portion 57 comes in to contact with the deep portion 58 of the shallow bottom portion 52.

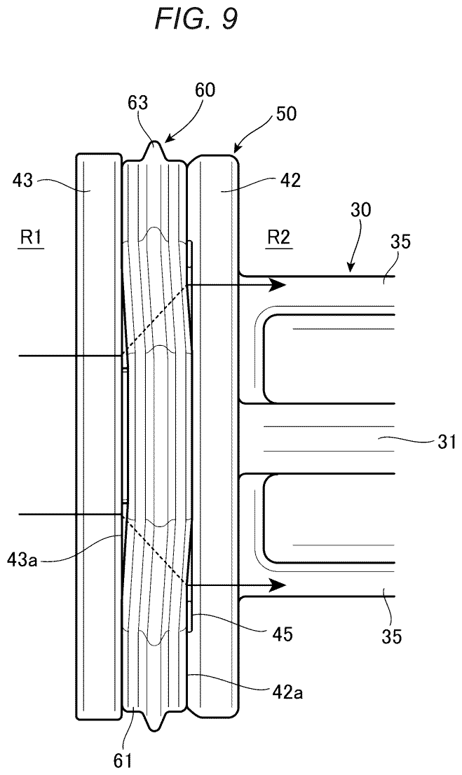

In the embodiment, when the piston 40 moves in the damper return direction F2, as shown in FIG. 9, a predetermined portion in the peripheral direction on one end portion in the axial direction of the seal ring 60 is deformed so as to enter the recessed portion 45 provided in the inner surface 42a of the first annular wall portion 42 of the annular groove 50, and a corresponding portion in the peripheral direction on the other end portion in the axial direction of the seal ring 60 (a portion corresponding to the portion deformed to enter the recessed portion 45) is separated from the inner surface 43a of the second annular wall portion 43 of the annular groove 50 to generate a gap.

As a result, as indicated by an arrow in FIG. 9, the air in the first chamber RI in the cylinder 20 passes through (1) a gap between a predetermined portion in the peripheral direction on the other end portion in the axial direction of the seal ring 60 and the inner surface 43a of the second annular wall portion 43, (2) a gap between the third annular protruding portion 67 of the seal ring 60 and the deep portion 58 of the shallow bottom portion 52, (3) a gap between the seal ring 60 and the deep bottom portion 51 (particularly, a gap between the seal ring 60 and the deep portion 56 of the deep bottom portion 51), and (4) a gap between the inner surface 42a of the first annular wall portion 42 and both side portions of the portion on the one end portion in the axial direction of the seal ring 60 that enters the recessed portion 45 in this order, and flows out to the second chamber R2 of the cylinder 20. As a result, the damper braking force is released. That is, when the piston 40 moves in the damper return direction F2, an exhaust flow path that exhausts the air in the first chamber R1 to the second chamber R2, is formed.

### Modifications

The shape and structure of a cylinder, a rod, a piston, a seal ring, and the like that form the damper device according to the present invention are not limited to those described above.

In the embodiment, the wall portion 21 of the cylinder 20 has a substantially cylindrical shape. Alternatively, the wall portion of the cylinder may be, for example, in the shape of a substantially prism or in the shape of a thin cylinder (a cylinder having a thin box shape). In this case, it is preferable that the rod, the piston, the seal ring, the seal cap, the detachment prevention cap, and the like are also shaped to correspond to the wall portion of the cylinder.

Further, in the embodiment, the cylinder 20 includes the end portion wall 25 disposed on the other end portion in the axial direction, and the through hole of the end portion wall 25 is opened and closed by the seal cap 70. Alternatively, for example, a closed end portion wall may be provided at the other end portion of the cylinder.

Further, in the embodiment, the rod 30 includes the shaft portion 31 and the pair of side walls 35 and 35 arranged on both sides of the shaft portion 31 via the plurality of ribs 35a. Alternatively, the rod may be, for example, a structure including only a shaft portion having a long plate shape or a column shape, as long as the rod 30 and the piston can be connected.

Further, in the embodiment, the pair of annular wall portions 42, 43 of the piston 40 are perpendicular to the axis P of the piston 40 and protrude at the same height. Alternatively, for example, one or both of the annular wall portions may be inclined at an angle other than 90° with respect to the axis of the piston, and may have different protruding amounts.

Further, the deep bottom portion 51 and the shallow bottom portion 52 of the annular groove 50 are parallel to the axial direction of the piston 40. Alternatively, the shallow bottom portion and the deep bottom portion may be tapered at a predetermined angle with respect to the axial direction of the piston, or may be curved or stepped.

Further, the inclination angle of the inclined portion 53 provided between the deep bottom portion 51 and the shallow bottom portion 52 with respect to the axial direction of the piston 40 is 90° (vertical). Alternatively, the inclined portion may be inclined, for example, at an angle other than 90° with respect to the axial direction of the piston.

Further, in the embodiment, by providing the deep portion 58 or the like in the shallow bottom portion 52, the exhaust flow path for the air in the first chamber R1 is formed when the piston 40 moves in the damper return direction F2 (see paragraph 0055). Alternatively, the exhaust flow path may be formed by providing a recessed groove extending in the axial direction in the shallow bottom portion.

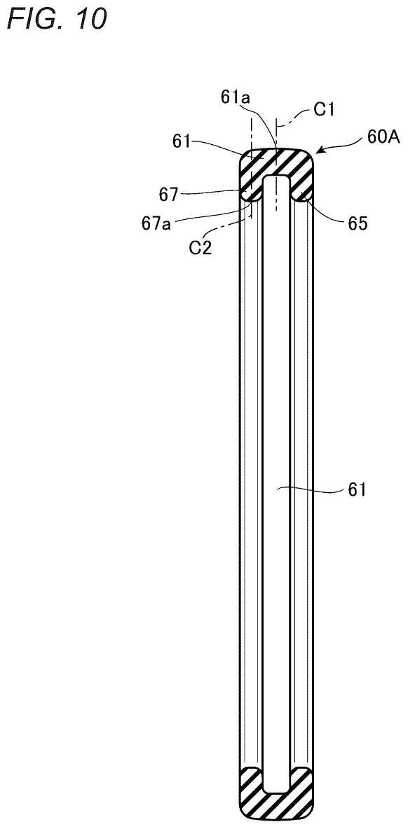

Further, the seal ring may have a shape as shown in FIG. 10, for example.

That is, a seal ring 60A shown in FIG. 10 has the same shape as the seal ring 60 shown in FIG. 7 except that the first annular protruding portion 63 is not provided as in the seal ring 60, and the outer peripheral surface of the base portion 61 is slightly curved. A top portion 61a (a portion positioned at the center in the axial direction) of the outer peripheral surface of the base portion 61 is the cylinder contact portion. In the seal ring 60A, similarly to the seal ring 60, the center C1 of the cylinder contact portion and the center C2 of the shallow bottom portion contact portion (the third annular protruding portion 67) are offset in the axial direction of the seal ring 60.

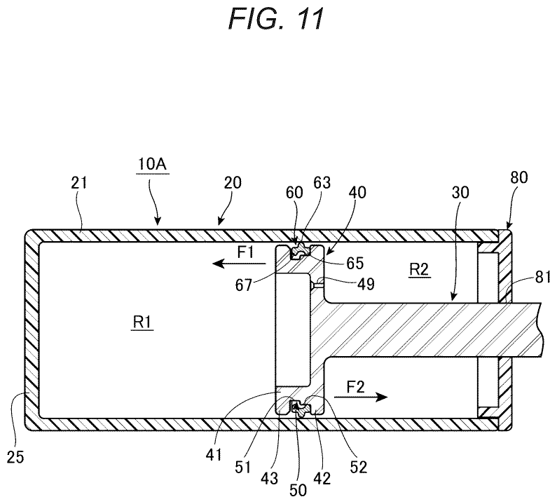

Further, in the embodiment, when the piston 40 moves in a direction away from the end portion wall 25 of the cylinder 20 (when the piston 40 moves in the damper braking direction F1), a braking force due to the pressure reduction in the first chamber R1 acts, and when the piston 40 moves in a direction toward the end portion wall 25 of the cylinder 20 (when the piston 40 moves in the damper return direction F2), the braking force is released. Alternatively, contrary to the above configuration, the damper braking force may be applied when the piston 40 moves in the direction toward the end portion wall 25 of the cylinder 20, and the damper braking force may be released when the piston 40 moves in the direction away from the end portion wall 25 of the cylinder 20. This will be described in another embodiment shown in FIG. 11.

In the embodiment, the one member is a fixed body such as an accommodation portion of an instrument panel, and the other member is an openable and closable body such as a glove box or a lid. Alternatively, the present disclosure is not limited thereto as long as the pair of members can approach and separate from each other.

Further, in the embodiment, the air chamber (the first chamber R1) is formed in the cylinder 20 on the side of the insertion direction of the rod 30 with respect to the seal ring 60. Alternatively, an air chamber may be provided in the cylinder on a side opposite to the insertion direction of the rod. For example, an exhaust hole is formed in an end portion wall of the cylinder, and a seal cap capable of opening and closing the exhaust hole is attached to a peripheral edge of the exhaust hole. Further, the cap mounted on the opening portion at the one end portion of the cylinder has a structure capable of sealing a peripheral edge of the opening portion, and capable of sealing a gap between the rod insertion port and the rod inserted through the rod insertion port, and a sealed air chamber is provided in the cylinder on the side opposite to the insertion direction of the rod. When the piston moves in the direction away from the end portion wall of the cylinder (moves in a direction opposite to the insertion direction of the rod), the air chamber is pressurized to exert a damper braking force. When the piston moves toward the end portion wall of the cylinder (moves in the insertion direction of the rod), the seal cap opens the exhaust hole, the air in the air chamber is exhausted, and the damper braking force is released.

### Operations and Effects

Next, operations and effects of the damper device 10 configured as described above will be described.

In the damper device 10, the piston 40 is in a stationary state in the cylinder 20 when the one member (fixed body or the like) and the other member (openable and closable body or the like) are close to each other. In this state, the seal ring 60 is disposed in the annular groove 50 in a state in which the top portion 63a of the first annular protruding portion 63 is in contact with the inner peripheral surface of the cylinder 20, and the top portion 67a of the third annular protruding portion 67 is in contact with the shallow bottom portion 52.

When the other member moves away from the one member from the above state (when the openable and closable body opens from the fixed body), the piston 40 moves in the damper braking direction F1 in the cylinder 20, and the rod 30 is pulled out from the opening portion 23 side of the cylinder 20. Then, the first chamber R1 in the cylinder 20 is depressurized as described in paragraph 0049, so that the damper braking force is applied to the piston 40, and the other member can be slowly moved with respect to the one member (the openable and closable body can be slowly opened from the fixed body).

In addition, when the other member is moved in a direction approaching the one member (when the openable and closable body is closed with respect to the fixed body), the piston 40 moves in the damper return direction F2 in the cylinder 20, and the rod 30 is pushed into the cylinder 20.

Then, the frictional force F2′ acts on the first annular protruding portion 63, which is the cylinder contact portion, from the inner peripheral surface of the cylinder 20 in the direction opposite to the damper return direction F2, so that the one end portion in the axial direction of the seal ring 60 is deformed toward the deep bottom portion 51 as indicated by the arrow F3 in FIG. 8 with the third annular protruding portion 67, which is the shallow bottom portion contact portion in contact with the shallow bottom portion 52, as a fulcrum. Here, the seal ring 60 is deformed in a rolling manner with the third annular protruding portion 67 as a fulcrum. As a result, the pressure contact force of the first annular protruding portion 63 with respect to the inner peripheral surface of the cylinder 20 is decreased, so that the frictional resistance between the inner peripheral surface of the cylinder 20 and the first annular protruding portion 63 can be reduced, and a force for operating the piston 40 when the piston 40 moves in the damper return direction F2 can be reduced. When the piston 40 moves in the damper return direction F2, as described in paragraphs 0054 and 0055, a part of the seal ring 60 enters the recessed portion 45 of the annular groove 50, and the air in the first chamber RI flows out to the second chamber R2 (see FIG. 9), thereby releasing the damper braking force. A similar effect can be achieved with a damper device having the seal ring 60A shown in FIG. 10.

Further, in the embodiment, as shown in FIG. 8, between the deep bottom portion 51 and the shallow bottom portion 52, there is a portion (inclined portion 53) inclined at an angle larger than an angle of the deep bottom portion 51 with respect to the axial direction of the piston 40 and an angle of the shallow bottom portion 52 with respect to the axial direction of the piston 40.

According to the above aspect, by providing the inclined portion 53 that is inclined at a larger angle with respect to the axial direction of the piston 40 between the deep bottom portion 51 and the shallow bottom portion 52, a portion that deepens stepwise can be provided between the deep bottom portion 51 and the shallow bottom portion 52. When the piston 40 moves in the damper return direction F2, the seal ring 60 is more likely to be deformed toward the deep bottom portion 51, so that the operating force in the damper return direction F2 can be reduced more effectively.

Further, the angle of the shallow bottom portion 52 with respect to the axial direction of the piston 40 can be made small, so that the shallow bottom portion contact portion (here, the third annular protruding portion 67) can be stably brought into contact with the shallow bottom portion 52, and a stable damper braking force can be obtained.

Further, in the embodiment, the seal ring 60 has the annular protruding portions 65 and 67 protruding from the inner periphery at both end portions in the axial direction. The annular protruding portion positioned on the side opposite to the damper braking direction F1 (third annular protruding portion 67) forms the shallow bottom portion contact portion, and the third annular protruding portion 67 is constantly positioned in the shallow bottom portion 52 and is in contact with the shallow bottom portion 52. The annular protruding portion positioned on the damper braking direction F1 side (second annular protruding portion 65) is positioned in the deep bottom portion 51, and does not come into contact with the deep bottom portion 51 when the piston 40 moves in the damper braking direction F1.

According to the above aspect, the third annular protruding portion 67 located on the side opposite to the damper braking direction F1 can ensure the thickness of the portion of the seal ring 60 on the side opposite to the damper braking direction F1. Therefore, when the piston 40 moves in the damper braking direction F1, the seal ring 60 is maintained in a stable posture, making it easier to maintain the sealing performance between the inner peripheral surface of the cylinder 20 and the outer peripheral surface of the piston 40 by the seal ring 60.

Further, the annular protruding portions 65 and 67 are provided on the inner periphery of the seal ring 60 at both end portions in the axial direction. Therefore, when the piston 40 moves in the damper return direction F2 and the seal ring 60 tries to be deformed toward the deep bottom portion 51, an inner peripheral portion 61b (see FIG. 7) of the seal ring 60 at an intermediate portion in the axial direction can be made less likely to come into contact a portion between the deep bottom portion 51 and the shallow bottom portion 52. As a result, the second annular protruding portion 65 positioned on the damper braking direction F1 side can be easily inserted into the deep bottom portion 51, so that the seal ring 60 can be easily deformed and excessive deformation of the seal ring 60 can be prevented.

In the embodiment, the shallow bottom portion 52 has the shallow portion 57 and the deep portion 58 in the peripheral direction of the annular groove 50, and the seal ring 60 is constantly in contact with the shallow portion 57 and the deep portion 58 of the shallow bottom portion 52 (see FIGS. 3 and 5).

According to the above aspect, the seal ring 60 is constantly in contact with the shallow portion 57 and the deep portion 58 of the shallow bottom portion 52, so that the shallow portion 57 maintains the frictional force between the inner peripheral surface of the cylinder 20 and the seal ring 60, thereby ensuring a predetermined damper braking force. In addition, the deep portion 58 of the shallow bottom portion 52 can reduce a crushing allowance of the seal ring 60 when the piston 40 moves in the damper return direction F2, so that excessive crushing deformation of the seal ring 60 can be prevented. As a result, the responsiveness when a state in which the piston 40 is stationary or moves in the damper braking direction F1 is switched to a state in which the piston 40 moves in the damper return direction F2 is enhanced, the frictional force between the inner peripheral surface of the cylinder 20 and the seal ring 60 can be smoothly reduced, and the force for operating the piston 40 can be quickly reduced. Therefore, it is possible to achieve a balance between the damper braking force when the piston 40 moves in the damper braking direction F1 and the operating force when the piston 40 moves in the damper return direction F2.

### Damper Device According to Another Embodiment

A damper device according to another embodiment of the present invention is shown in FIG. 11. The same reference signs are given to substantially the same parts as those in the above-described embodiments, and description thereof will be omitted.

A damper device 10A according to the embodiment is structured in a manner opposite to that of the damper device 10 shown in FIGS. 1 to 10, in which a braking force is applied when the piston 40 moves in a direction approaching the end portion wall 25 of the cylinder 20, and the braking force is released when the piston 40 moves in a direction away from the end portion wall 25 of the cylinder 20.

That is, in the embodiment, the arrangement of the deep bottom portion 51 and the shallow bottom portion 52 on the bottom portion of the annular groove 50 is opposite to the arrangement of the deep bottom portion 51 and the shallow bottom portion 52 in the damper device 10 shown in FIGS. 1 to 10.

Specifically, as shown in FIG. 11, in the bottom portion of the annular groove 50, the deep bottom portion 51 is disposed on the damper braking direction F1 side, and the shallow bottom portion 52 is disposed on the damper return direction F2 side. The other end portion of the cylinder 20 is closed by the end portion wall 25. Further, an orifice 49 that allows the first chamber R1 and the second chamber R2 to communicate with each other is formed at a predetermined position of the piston 40.

When the other member moves in a direction approaching the one member and the piston 40 moves in the damper braking direction F1, the first chamber R1 in the cylinder 20 is pressurized and a damper braking force is applied to the piston 40. Further, when the other member moves in a direction away from the one member and the piston 40 moves in the damper return direction F2, the other end portion in the axial direction of the seal ring 60 is deformed toward the deep bottom portion 51, so that the frictional resistance between the inner peripheral surface of the cylinder 20 and the first annular protruding portion 63 is reduced, and the force for operating the piston 40 is reduced.

### Damper Device According to Still Another Embodiment

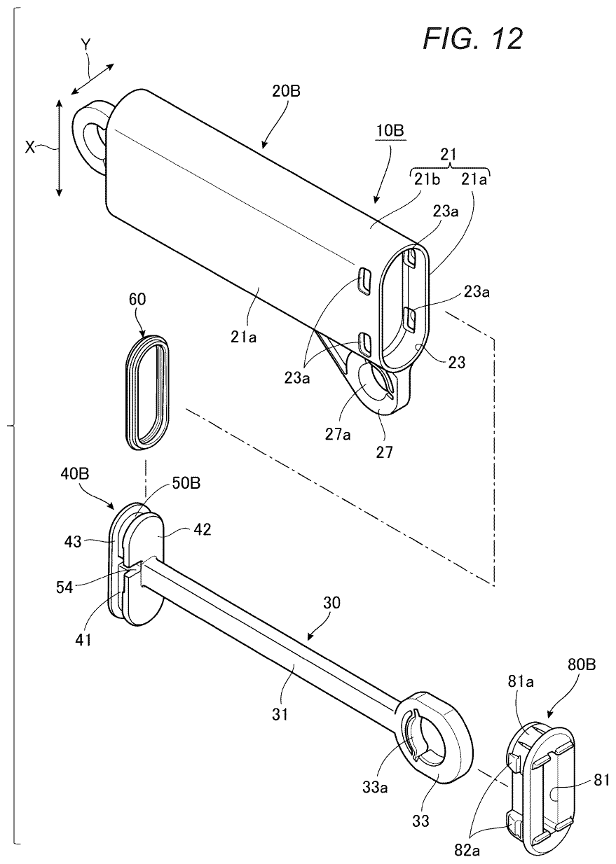

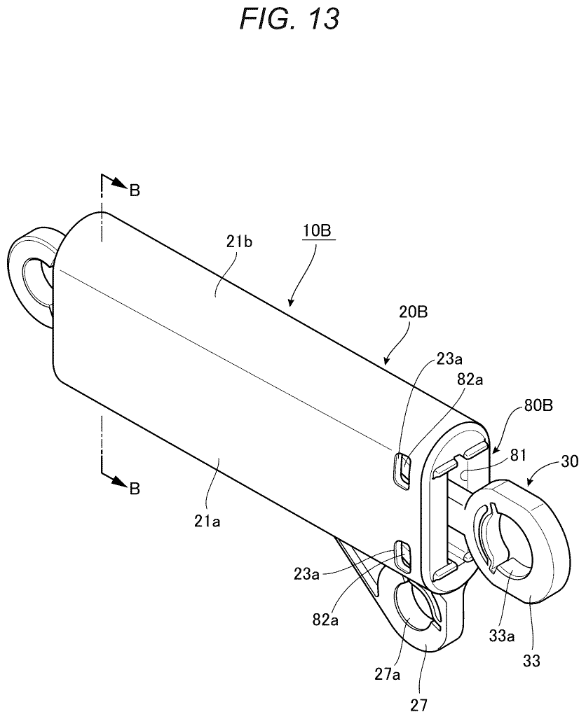

FIGS. 12 to 18 show a damper device according to still another embodiment of the present invention. The same reference signs are given to substantially the same parts as those in the above-described embodiments, and description thereof will be omitted.

A damper device 10B according to the embodiment is mainly different from the above-described embodiments in the shape of a cylinder 20B, the shape of a piston 40B, and the shape of an annular groove 50B.

As shown in FIG. 12, the cylinder 20B has a wall portion 21 extending in a tubular shape, and a cross section of the wall portion 21 perpendicular to the axial direction has a cross-sectional shape having a major axis X and a minor axis Y, and is formed into a thin tubular shape (a tubular shape resembling a thin box) with a major axis X side being wider and a minor axis Y side being narrower.

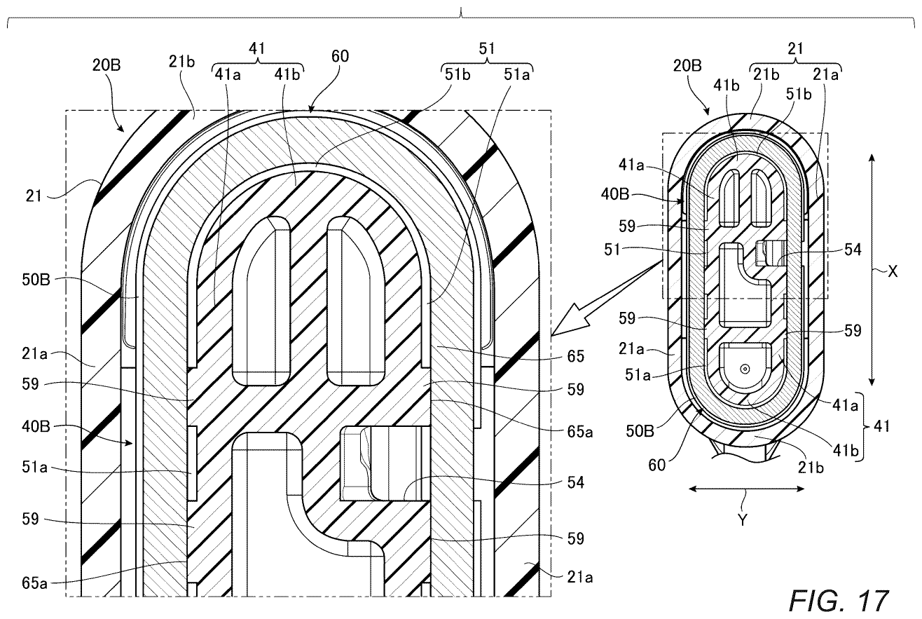

As shown in FIGS. 12 and 17, in the wall portion 21 of the cylinder 20B, a direction along the major axis X is referred to as a “major axis direction”, and a direction along the minor axis Y is referred to as a “minor axis direction”. The same applies to components of the piston 40B, which will be described later.

Specifically, the wall portion 21 has a pair of major-axis side wall portions 21a and 21a that extend linearly along the major axis direction and are arranged to face each other in parallel, and a pair of minor-axis side wall portions 21b and 21b that are arranged in the minor axis direction, connect both end portions of the pair of major-axis side wall portions 21a and 21a to each other and are bent in an arc shape.

One end portion in the axial direction of the wall portion 21 is opened, and the opening portion 23 is provided. Further, the major-axis side wall portions 21a and 21a arranged to face each other around a peripheral edge of the opening portion 23 are formed with engaging holes 23a and 23a, respectively.

An end portion wall (not shown) is disposed at the other end portion of the wall portion 21 in the axial direction to close the other end portion of the wall portion 21.

As shown in FIG. 12, a detachment prevention cap 80B attached to the opening portion 23 of the cylinder 20B bas a peripheral wall portion 81a that fits onto the wall portion 21 of the cylinder 20B.

Next, the piston 40B will be described.

The piston 40B according to the embodiment has a cross-sectional shape having a major axis and a minor axis that fits with the wall portion 21 of the cylinder 20B.

That is, as shown in FIG. 17, the peripheral wall portion 41 of the piston 40B according to the embodiment has a pair of major-axis side wall portions 41a and 41a that extend linearly along the major axis direction and are arranged to face each other in parallel, and a pair of minor-axis side wall portions 41b and 41b that are arranged in the minor axis direction, connect both end portions of the pair of major-axis side wall portions 41a and 41a to each other and are bent in an arc shape.

As shown in FIG. 17, the deep bottom portion 51 disposed on the damper braking direction F1 side of the bottom portion of the annular groove 50 (the outer peripheral portion of the peripheral wall portion 41) has a pair of major-axis side deep bottom portions 51a, 51a formed on a side of the pair of major-axis side wall portions 41a, 41a, and a pair of minor-axis side deep bottom portions 51b, 51b formed on a side of the pair of minor-axis side wall portions 41b, 41b.

Further, an air flow groove 54 is formed on at least one of both side portions in the major axis direction of an outer periphery of the piston 40B. The air flow groove 54 forms a recessed groove deeper than the deep bottom portion 51, extends in the axial direction, and allows air to flow through when the piston 40B moves in the return direction opposite to the damper braking direction.

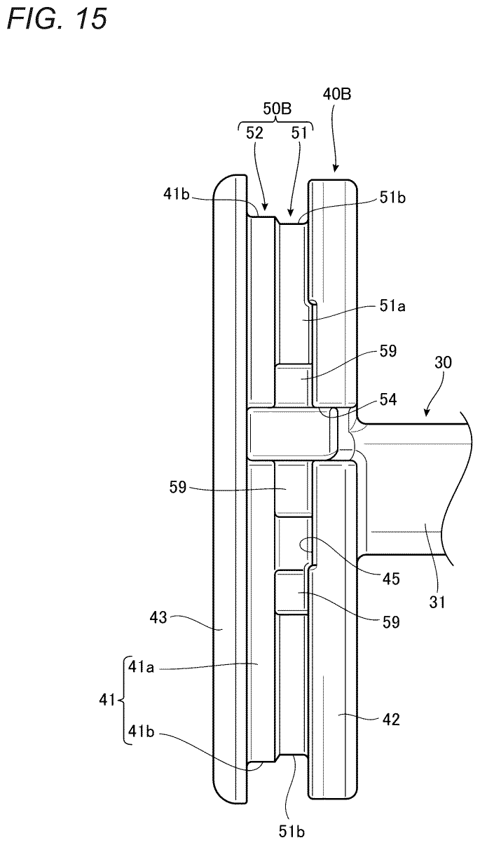

In the embodiment, as shown in FIG. 15, the air flow groove 54 is formed in one of the pair of major-axis side wall portions 41a and 41a of the peripheral wall portion 41 at a location offset toward one of the minor-axis side wall portions 41b from the center in the major axis direction of the one major-axis side wall portion 41a.

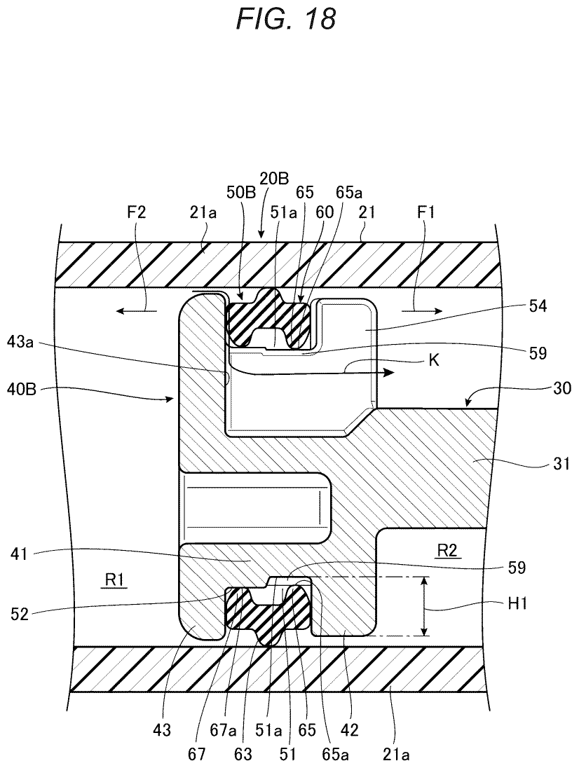

Further, as shown in FIG. 18, a depth of the air flow groove 54 (a length of the air flow groove 54 in the radial direction from the outer peripheral surface of the piston) is formed deeper than the depth Hl of the deep bottom portion 51 (a length of the deep bottom portion 51 in the radial direction from the outer peripheral surface of the piston), and has a concave groove shape extending along the axial direction of the piston 40B.

When the piston 40B moves in the damper return direction F2 (see FIG. 18) opposite to the damper braking direction F1, a predetermined portion in the peripheral direction on one end portion in the axial direction of the seal ring 60 is deformed so as to enter the recessed portion 45 of the first annular wall portion 42 of the annular groove 50B, and a corresponding portion in the peripheral direction on the other end portion in the axial direction of the seal ring 60 is separated from the inner surface 43a of the second annular wall portion 43 of the annular groove 50 to generate a gap.

Then, as indicated by an arrow K in FIG. 18, the air in the first chamber R1 in the cylinder 20B flows into the air flow groove 54 from the gap between the predetermined portion in the peripheral direction on the other end portion in the axial direction of the seal ring 60 and the inner surface 43a of the second annular wall portion 43, and then passes through the air flow groove 54 and flows out to the second chamber R2 of the cylinder 20B, so that the damper braking force is released.

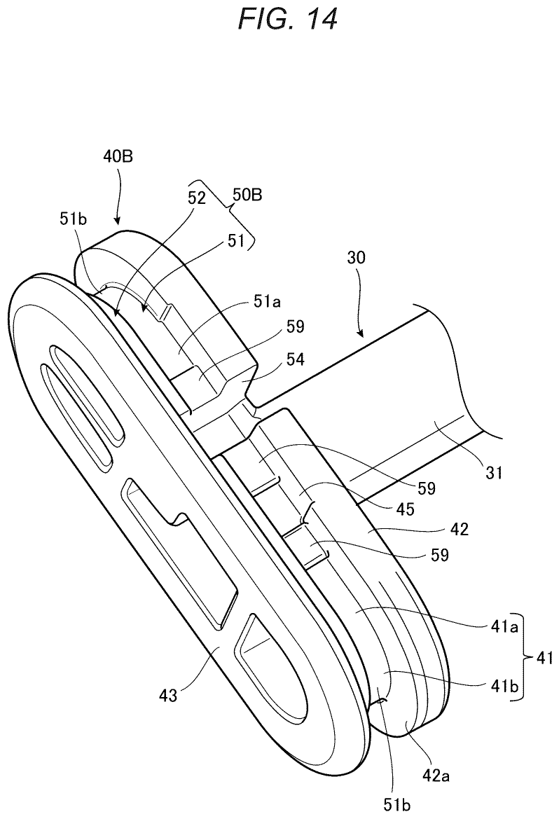

Further, as shown in FIGS. 14 to 18, a protruding portion 59 protrudes from the bottom surface of the major-axis side deep bottom portion 51a. The protruding portion 59 can come into contact with the inner peripheral surface of the seal ring 60 at least when the piston 40B moves in the damper return direction F2 (see FIG. 18).

Further, a plurality of protruding portions 59 protrude from the bottom surface of the major-axis side deep bottom portion 51a at predetermined intervals in the major axis direction of the piston 40B. The protruding portions 59 are provided at least on both side portions of the air flow groove 54 in the major axis direction of the piston 40B.

More specifically, each protruding portion 59 in the embodiment is a thin-walled protrusion that protrudes from the bottom surface of the major-axis side deep bottom portion 51a at a predetermined height and has a rectangular shape (here, a substantially square shape) (see FIG. 14). Further, a ceiling surface of each protruding portion 59 (a surface that protrudes highest from the bottom surface of the major-axis side deep bottom portion 51a) has a flat surface shape without unevenness.

A protrusion height (height of the ceiling surface) of each protruding portion 59 from the bottom surface of the major-axis side deep bottom portion 51a is set to be equal to or lower than the bottom surface of the shallow bottom portion 52. In the embodiment, as shown in FIG. 18, the height of the ceiling surface of each protruding portion 59 is lower than the bottom surface of the shallow bottom portion 52.

Further, in the embodiment, as shown in FIGS. 14, 15, and 17, a pair of protruding portions 59, 59 protrude from the bottom surface of one major-axis side deep bottom portion 51a on both side edges in the major axis direction of the air flow groove 54, and another protruding portion 59 protrudes from a position spaced apart in the major axis direction from one protruding portion 59 (the protruding portion 59 located below in FIGS. 14 and 15) of the pair of protruding portions 59, 59. A total of three protruding portions 59 are provided.

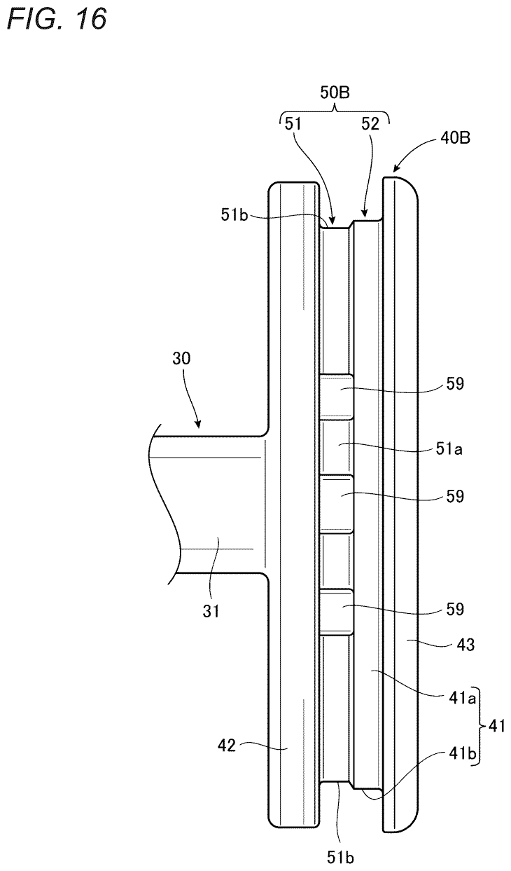

On the other hand, as shown in FIGS. 16 and 17, three protruding portions 59 protrude from the bottom surface of the other major-axis side deep bottom portion 51a at predetermined intervals in the major axis direction.

That is, in the embodiment, three protruding portions 59 are provided on each of the major-axis side deep bottom portions 51a, totaling six protruding portions 59.

As shown in FIG. 18, in the seal ring 60 of the embodiment, the top portion 67a of the third annular protruding portion 67 positioned on the damper return direction F2 side is in constant contact with the shallow bottom portion 52 of the annular groove 50, and the top portion 65a of the second annular protruding portion 65 located on the damper braking direction F1 side is in constant contact with the ceiling surface of the protruding portion 59. That is, the protruding portion 59 is in constant contact with the second annular protruding portion 65 (including when the piston 40B moves in the damper return direction F2).

As described above, the second annular protruding portion 65 and the protruding portion 59 are in contact with each other. However, the second annular protruding portion 65 is not in contact with the deep bottom portion 51 itself.

The number and layout of the protruding portions are not particularly limited, but it is preferable that at least one protruding portion is provided on each major-axis side deep bottom portion 51a. The shape of the protruding portion may be, for example, a circular protrusion, an elliptical protrusion, a narrow rib, and the like, as long as the protruding portion can come into contact with the inner peripheral surface of the seal ring when the piston moves in the damper return direction.

Further, in the embodiment, the seal ring 60 has the annular protruding portions 65 and 67 protruding from the inner peripheral surface at both end portions in the axial direction. The annular protruding portion positioned on the side opposite to the damper braking direction F1 (third annular protruding portion 67) forms the shallow bottom portion contact portion, and the third annular protruding portion 67 is constantly positioned in the shallow bottom portion 52 and is in contact with the shallow bottom portion 52. The second annular protruding portion 65 positioned on the damper braking direction F1 side is positioned in the deep bottom portion 51, and does not come into contact with the deep bottom portion 51 when the piston 40B moves in the damper braking direction F1. The third annular protruding portion 67 positioned on the side opposite to the damper braking direction F1 and the second annular protruding portion 65 positioned on the damper braking direction FI side protrude from the inner peripheral surface of the seal ring 60 at the intermediate portion in the axial direction by the same amount. The protruding portion 59 can come into contact with the second annular protruding portion 65 positioned on the damper braking direction F1 side.

Next, operations and effects of the damper device 10B configured as described above will be described.

That is, in the damper device 10B according to the embodiment, the protruding portion 59 protrudes from the bottom surface of the major-axis side deep bottom portion 51a. The protruding portion 59 can come into contact with the inner peripheral surface of the seal ring 60 when the piston 40B moves in the damper return direction F2.

According to the above aspect, it possible to make the portion of the seal ring 60 located in the major axis direction, which is inherently difficult to be stabilized, less likely to roll over or tilt while reducing an operating load (pressing load) of the piston 40B when the piston 40B moves in the damper return direction F2, which makes it easier to maintain the seal ring 60 in a stable posture. Therefore, when the piston 40B moves in the damper return direction F2, comes to a stop, and then moves again in the damper braking direction F1, a stable braking force can be exerted.

Further, in the embodiment, a plurality of protruding portions 59 protrude from the bottom surface of the major-axis side deep bottom portion 51a at predetermined intervals in the major axis direction of the piston 40B.

According to the above aspect, since the plurality of protruding portions 59 protrude as described above, the portion of the seal ring 60 that is positioned in the major axis direction of the piston 40B is stably supported over a wide range. The frictional force of the cylinder contact portion (the first annular protruding portion 63) to come into contact with the inner peripheral surface of the cylinder 20B is appropriately adjusted. The seal ring 60 can be easily maintained in a more stable posture while reducing the operating load when the piston 40B moves in the damper return direction F2.

Further, in the embodiment, the air flow groove 54 is formed on at least one of both side portions in the major axis direction of the outer periphery of the piston 40B. The air flow groove 54 forms a recessed groove deeper than the deep bottom portion 51 and extends in the axial direction. The protruding portions 59 are provided at least on both side portions of the air flow groove 54 in the major axis direction of the piston 40B.

According to the above aspect, both side portions of the air flow groove 54 are locations where the posture of the seal ring 60 is particularly difficult to stabilize, but by providing the protruding portions 59, 59 at such locations, the seal ring 60 can be easily maintained in a stable posture.

In addition, according to the configuration described in paragraph 0114, the same effects as those described in paragraphs 0078 (maintenance of sealing between the inner peripheral surface of the cylinder and the outer peripheral surface of the piston) and 0079 (making the seal ring 60 easier to be deformed and preventing excessive deformation) can be obtained.

Further, there is no directionality involved when mounting the seal ring 60 onto the annular groove 50, so that the seal ring 60 can be easily mounted onto the annular groove 50, and it is easy to prevent the seal ring 60 from rolling over or tilting and being deformed when the piston 40B moves in the damper return direction F2.

The present invention is not limited to the embodiments described above, various modifications can be made within the scope of the gist of the present invention, and such embodiments are also included in the scope of the present invention.

### REFERENCE SIGNS LIST

10, 10A, 10B damper device
20, 20B cylinder
23: opening portion
30 rod
40, 40B piston
50 annular groove
51 deep bottom portion
52 shallow bottom portion
53 inclined portion
54 air flow groove
57 shallow portion
58 deep portion
59 protruding portion
60, 60A seal ring
63 first annular protruding portion
65 second annular protruding portion
67 third annular protruding portion
70 seal cap
80, 80B detachment prevention cap

1. A damper device configured to be attached between a pair of members that are configured to move toward or away from each other, and configured to apply a braking force when the pair of members move toward or away from each other, the damper device comprising:
a cylinder having an opening portion at one end portion;
a rod movably inserted into the cylinder through the opening portion;
a piston connected to the rod and having an annular groove formed on an outer periphery thereof; and
a seal ring mounted in the annular groove and configured to come into pressure contact with an inner peripheral surface of the cylinder,
wherein a bottom portion of the annular groove is provided with a deep bottom portion disposed on a side of a damper braking direction, and a shallow bottom portion disposed on a side opposite to the damper braking direction and shallower than the deep bottom portion,
wherein the seal ring is provided with, on an outer peripheral surface thereof, a cylinder contact portion configured to come into contact with the inner peripheral surface of the cylinder, and is provided with, on an inner peripheral surface thereof, a shallow bottom portion contact portion configured to come into contact with the shallow bottom portion, a center of the cylinder contact portion and a center of the shallow bottom portion contact portion are offset in an axial direction, and
wherein the inner peripheral surface of the seal ring does not come into contact with the deep bottom portion when the piston moves in the damper braking direction, and is configured to come into contact with the shallow bottom portion when the piston moves in a return direction opposite to the damper braking direction.

2. The damper device according to claim 1,
wherein a portion inclined at an angle larger than an angle of the deep bottom portion with respect to the axial direction of the piston and an angle of the shallow bottom portion with respect to the axial direction of the piston, is provided between the deep bottom portion and the shallow bottom portion.

3. The damper device according to claim 1-or 2,
wherein the seal ring has annular protruding portions protruding from the inner peripheral surface at both end portions in the axial direction,
wherein the annular protruding portion positioned on the side opposite to the damper braking direction forms the shallow bottom portion contact portion, and the annular protruding portion is constantly positioned in the shallow bottom portion and is in contact with the shallow bottom portion, and
wherein the annular protruding portion positioned on the side of the damper braking direction is positioned in the deep bottom portion, and does not come into contact with the deep bottom portion when the piston moves in the damper braking direction.

4. The damper device according to claim 1 or 2,
wherein the shallow bottom portion has a shallow portion and a deep portion in a peripheral direction of the annular groove, and
wherein the seal ring is constantly in contact with the shallow portion and the deep portion of the shallow bottom portion.

5. The damper device according to claim 1,
wherein the cylinder has a wall portion extending in a tubular shape, a cross section of the wall portion perpendicular to the axial direction has a cross-sectional shape having a major axis and a minor axis,
wherein the piston has a cross-sectional shape having a major axis and a minor axis that is configured to fit with the wall portion of the cylinder,
wherein the deep bottom portion has at least a major-axis side deep bottom portion formed in a major axis direction of the piston, and
wherein a protruding portion protrudes from a bottom surface of the major-axis side deep bottom portion, and the protruding portion is configured to come into contact with the inner peripheral surface of the seal ring at least when the piston moves in the return direction opposite to the damper braking direction.

6. The damper device according to claim 5,
wherein a plurality of the protruding portions protrude from the bottom surface of the major-axis side deep bottom portion at predetermined intervals in the major axis direction of the piston.

7. The damper device according to claim 6,
wherein an air flow groove having a recessed groove shape deeper than the deep bottom portion and extending in the axial direction, is formed on at least one side portion of both side portions positioned in the major axis direction of an outer periphery of the piston, and
wherein the protruding portions are provided at least on both side portions of the air flow groove in the major axis direction of the piston.
